(19) United States
(12) Patent Application Publication
(10) Pub. No.: US 2009/0084640 A1
(43) Pub. Date: Apr. 2, 2009

(54) BRAKE ARRANGEMENT

(76) Inventor: YU-YU CHEN, TAIPEI CITY (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/862,467

(22) Filed: Sep. 27, 2007

(51) Int. Cl. B60L 7/00

(52) U.S. Cl. 188/164

(57) ABSTRACT

A brake arrangement includes a rotor, an annular magnet located at an inner circumferential surface of the rotor, a laminated silicon steel structure, plural sets of coils, and a brake mechanism. The laminated silicon steel structure is formed by stacking a plurality of annular silicone steel sheets, each of which is assembled from several segments. Each of the silicone steel sheets includes a plurality of coil winding sections, each of which has a polar end oriented toward and spaced from an inner circumferential surface of the annular magnet by a predetermined clearance. The plural sets of coils are separately wound on the coil winding sections. The brake mechanism is arranged near the rotor and includes a core and at least two electromagnetic coils separately wound on two electromagnetic coil winding sections on the core.

### FIELD OF THE INVENTION

The present invention relates to a brake, and more particularly to a brake arrangement.

### BACKGROUND OF THE INVENTION

The brake for most currently available motion apparatus generally includes a rotor, a stator, an annular magnet, and a brake mechanism. The rotor is rotatably mounted to an outer side of the stator. The brake mechanism is mounted to an outer side of the rotor for generating and applying a braking force against the rotor. In some designs, the annular magnet is located at an inner circumferential surface of the rotor. On the stator, there is mounted a laminated silicon steel structure, which is formed by stacking a plurality of silicon steel sheets. Plural sets of coils are separately wound on projected sections formed on the laminated silicon steel structure. Each of the projected sections of the laminated silicon steel structure has a polar end oriented toward and spaced from an inner circumferential surface of the annular magnet by a predetermined clearance. The brake mechanism includes a silicon steel core and one set of electromagnetic coil wound around the silicon steel core.

U.S. Pat. No. 6,581,731 discloses an autonomous generation brake assembly, which includes a first rotor unit, a stator unit, and a second rotor unit. The first rotor unit includes a power-generating coil, a rotor, and a permanent magnet. The stator unit includes an outer rim, an inner rim, and a central opening. When the first rotor unit operates, the power-generating coil works with the second rotor unit to generate an eddy current and an electric field to thereby create a braking force.

As shown in FIG. 1, the silicon steel sheet 1 for the above-described conventional brake comprises an annular sheet defining a hollow central area 11, and is produced by punching a whole piece of silicon steel material A. To form the hollow central area 11 by punching the silicon steel material A, a large amount of scrap A1, A2 is produced. That is, there is a very high material loss, and the silicon steel material A has a use ratio as low as 22.15%. Therefore, a large quantity of material is wasted, making the conventional brake design not economical for use, particularly when the world is facing the problems of energy crisis and working for environmental protection.

In addition, as can be seen from FIG. 2, the brake mechanism for the above-described conventional brake is arranged in the vicinity of a cast iron wheel 14, and includes a silicon steel core 12 and a set of electromagnetic coil 13 wound around an electromagnetic coil winding section 121 of the core 12. In principle, the temperature of the electromagnetic coil is directly proportional to the ampere-turn of the electromagnetic coil. Therefore, the above design with only one single set of electromagnetic coil wound on the silicon steel core of the brake mechanism would dangerously result to a high temperature of 145° at the brake mechanism.

FIG. 3 shows another conventional brake mechanism, which is arranged in a cast iron wheel 14 and has a stator 15 mounted to a center thereof. The brake mechanism illustrated in FIG. 3 includes a plurality of electromagnetic coil winding sections 16 and plural sets of electromagnetic coils 17 separately wound on the electromagnetic coil winding sections 16. When an amount of current is supplied to the electromagnetic coils 17, all the magnetic field lines produced by the electromagnetic coils 17 flow upward along the center of the coils. Under this condition, the brake mechanism is still subjected to a high temperature.

### SUMMARY OF THE INVENTION

It is therefore a primary object of the present invention to provide a brake arrangement that can reduce the consumption of and lessen the loss of silicon steel material.

Another object of the present invention is to provide a brake arrangement that includes a brake mechanism having at least two sets of electromagnetic coils to solve the problem of high temperature at operation.

A further object of the present invention is to provide a brake arrangement that includes a brake mechanism having at least two sets of electromagnetic coils, so that when a current is supplied to the electromagnetic coils, two groups of magnetic lines separately having an upward and a downward direction are produced, and accordingly a lower temperature is generated at the brake mechanism.

To achieve the above and other objects, the brake arrangement according to an embodiment of the present invention includes a rotor, an annular magnet located at an inner circumferential surface of the rotor, a laminated silicon steel structure, plural sets of coils, and a brake mechanism. The laminated silicon steel structure is formed by stacking a plurality of annular silicone steel sheets, each of which is assembled from several segments. Each of the silicone steel sheets includes an annular body and a plurality of coil winding sections equally spaced along and radially projected from an outer circumferential surface of the annular body. Each of the coil winding sections has a polar end oriented toward and spaced from an inner circumferential surface of the annular magnet by a predetermined clearance. The plural sets of coils are separately wound on the coil winding sections of the laminated silicon steel structure. The brake mechanism is arranged near the rotor for generating and applying a braking force against the rotor; and includes a core and at least two sets of electromagnetic coils separately wound on at least two electromagnetic coil winding sections on the core.

Since each of the annular silicon steel sheets for forming the laminated silicon steel structure is assembled from multiple pieces of segments, these segments may be punched from one single piece of silicon steel material to maximize the use of material, and thereby it saves a lot of production cost, making the present invention economical and environment-friendly. Moreover, with the at least two sets of electromagnetic coils provided in the brake mechanism, it is possible to effectively lower the temperature of the brake mechanism while increase the brake efficiency thereof.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a production of a silicon steel sheet from a piece of silicon steel material for a conventional brake;

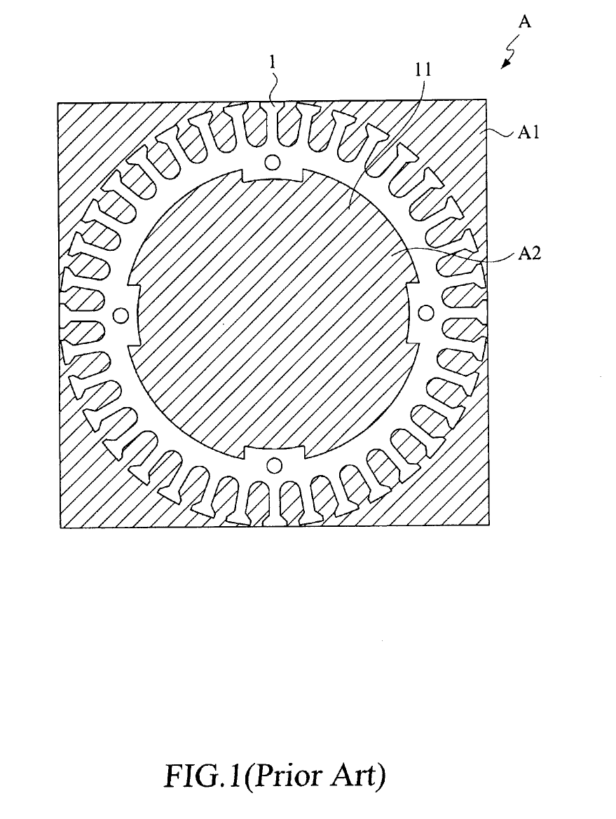

FIG. 2 shows a brake mechanism of a conventional brake;

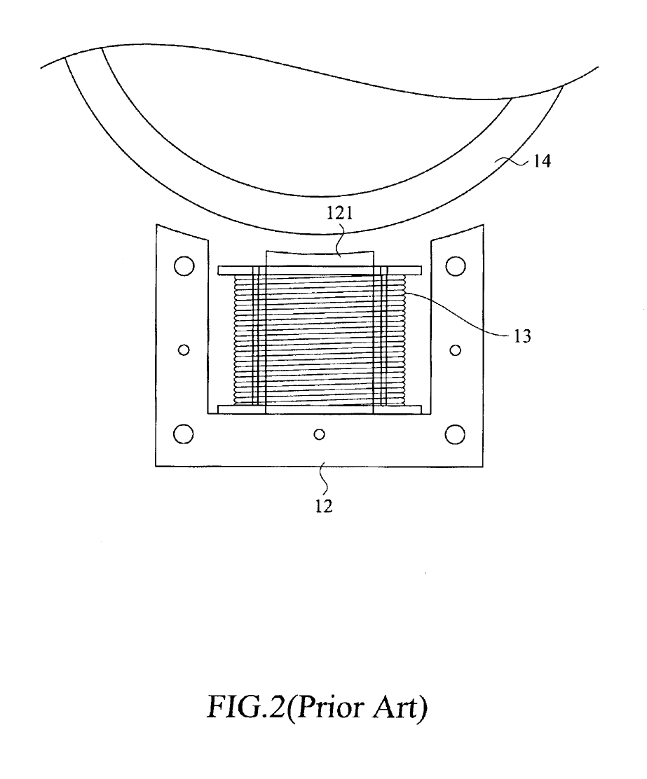

FIG. 3 shows a brake mechanism of another conventional brake;

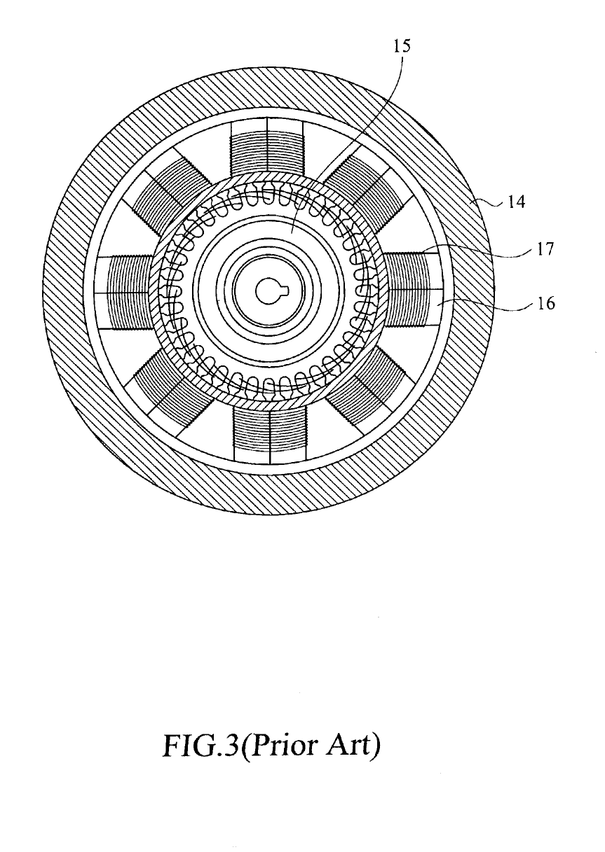

FIG. 4 is a perspective view of a brake arrangement according to a first embodiment of the present invention;

FIG. 5 shows a top view of an assembled annular silicon steel sheet of the brake arrangement of the present invention;

FIG. 6 shows a production of the segments of the annular silicon steel sheet of FIG. 5 from a piece of silicon steel material according to a first embodiment of the annular silicon steel sheet of the present invention;

FIG. 7 is a top view of a laminated silicon steel structure for the brake arrangement of the present invention with coils wound thereon;

FIG. 8 shows a brake mechanism of the brake arrangement of the present invention;

FIG. 9 shows a production of the segments of an annular silicon steel sheet according to a second embodiment of the annular silicon steel sheet of the present invention; and

FIG. 10 is a perspective view of a brake arrangement according to another embodiment of the present invention.

### DETAILED DESCRIPTION OF THE PREFERRED EMBODIMENTS

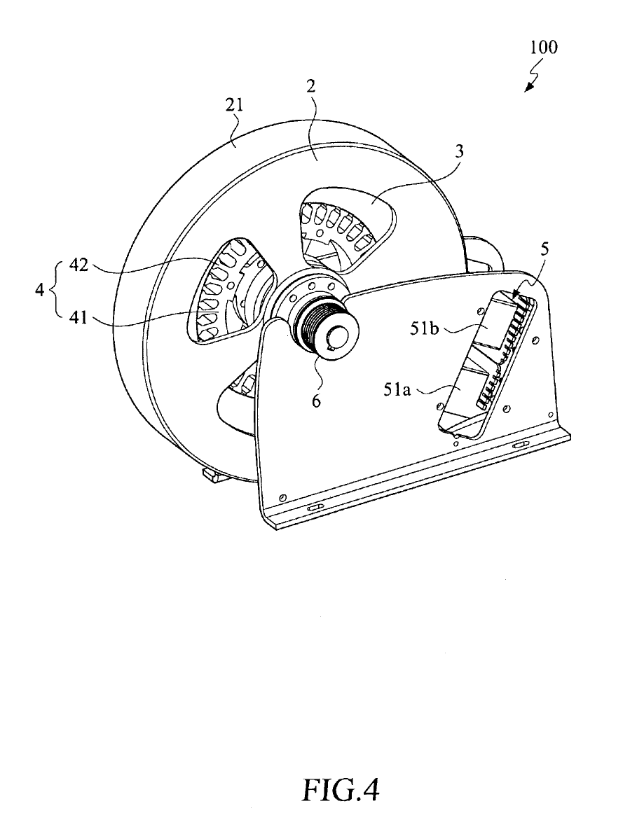

Please refer to FIG. 4 that is a perspective view of a brake arrangement 100 according to a first embodiment of the present invention. As shown, the brake arrangement 100 includes a rotor 2, an annular magnet 3, a laminated silicon steel structure 4, a brake mechanism 5, and a mount 6. The annular magnet 3 is located at an inner circumferential surface of the rotor 2. The laminated silicon steel structure 4 includes an annular body 41 and a plurality of coil winding sections 42 equally spaced along and radially projected from an outer circumferential surface of the annular body 41. Each of the coil winding sections 42 has a polar end, which is oriented toward and spaced from an inner circumferential surface of the annular magnet 3 by a predetermined clearance. The brake mechanism 5 is arranged in the vicinity of the rotor 2 for generating and applying a braking force against the rotor 2. An iron ring 21 is mounted to an outer circumferential surface of the rotor 2 to increase a magnetic attraction between the brake mechanism 5 and the rotor 2. The mount 6 is associated with the laminated silicon steel structure 4 for holding the latter in place.

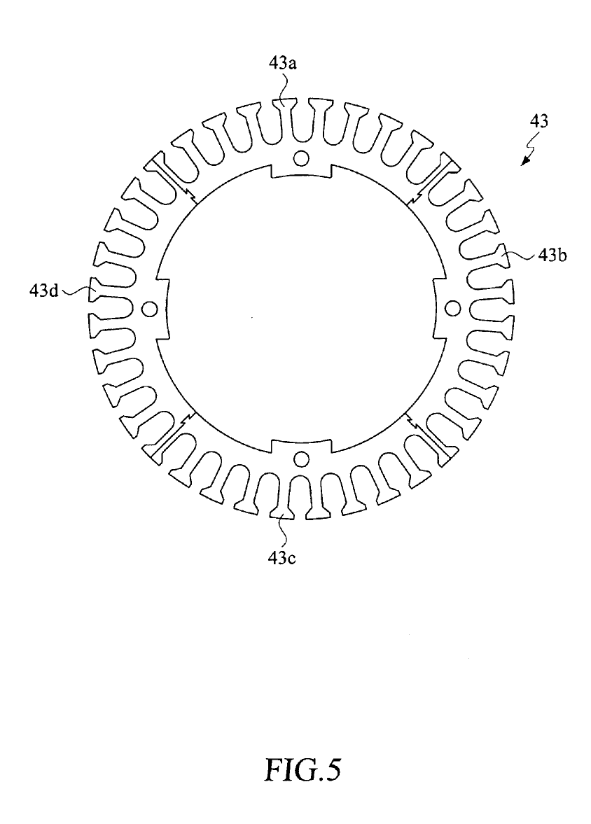

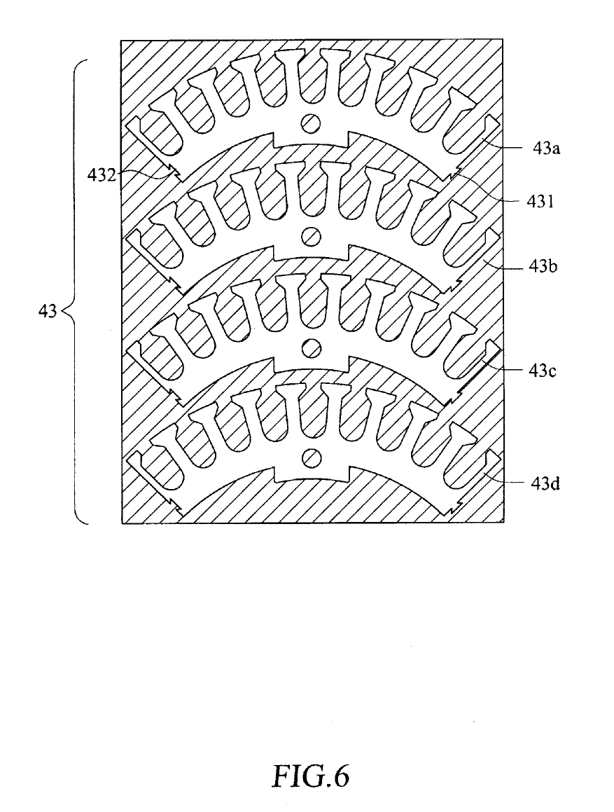

Please refer to FIGS. 5 and 6 at the same time. The laminated silicon steel structure 4 is formed by stacking a plurality of annular silicon steel sheets 43. Each of the annular silicon steel sheets 43 is assembled from four pieces of identical segments 43a, 43b, 43c, 43d. Each of the four segments 43a, 43b, 43c, 43d is provided at a left end with a male connector 431 and at a right end with a mating female connector 432, so that the four segments 43a, 43b, 43c, 43d could be sequentially connected to form the annular silicon steel sheet 43 through engagement of the male connector 431 of one segment with the mating female connector 432 of an adjacent segment.

Since each of the annular silicon steel sheets 43 is assembled from four pieces of identical segments 43a, 43b, 43c, 43d, the four segments 43a, 43b, 43c, 43d may be punched from one single piece of silicon steel material that maximizes the use of material with reduced scrap. With the design of the annular silicon steel sheet 43 of the present invention, the silicon steel material may have a use ratio up to 37%, and accordingly, it reduces the production cost significantly and lessens the waste of material, making the present invention economical and environment-friendly.

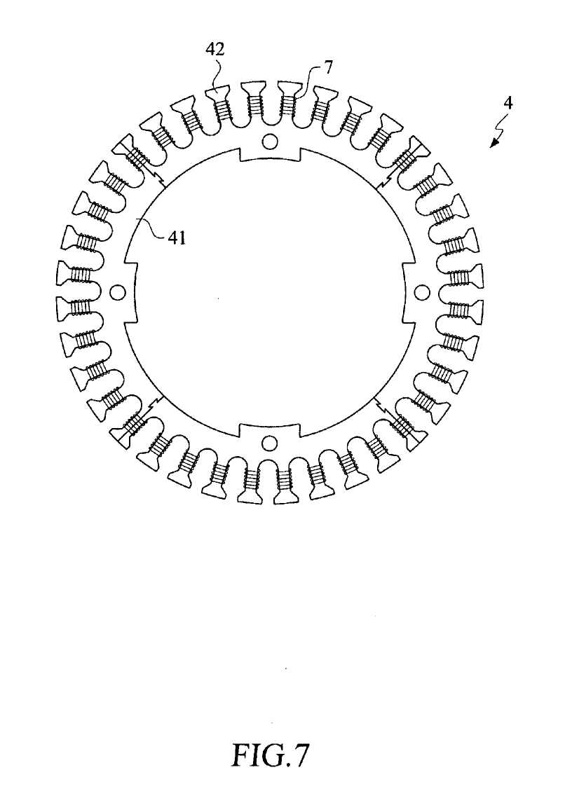

As can be seen from FIG. 7, the brake arrangement 100 includes plural sets of coils 7 separately wound on the coil winding sections 42 of the laminated silicon steel structure 4. When the rotor 2 rotates, the annular magnet 3 is driven by the rotor 2 to rotate simultaneously, so that the coils 7 are induced to produce an electromotive force. Power generated from the induced electromotive force is supplied to the brake mechanism 5. It is understood by those skilled in the art that the coils 7 illustrated in FIG. 7 are wound on the coil winding sections 42 by one of many available winding manners. Other winding manners, such as forming one coil 7 on two coil winging sections 42, or crossing two coils 7 on two coil winging sections 42, may also be used.

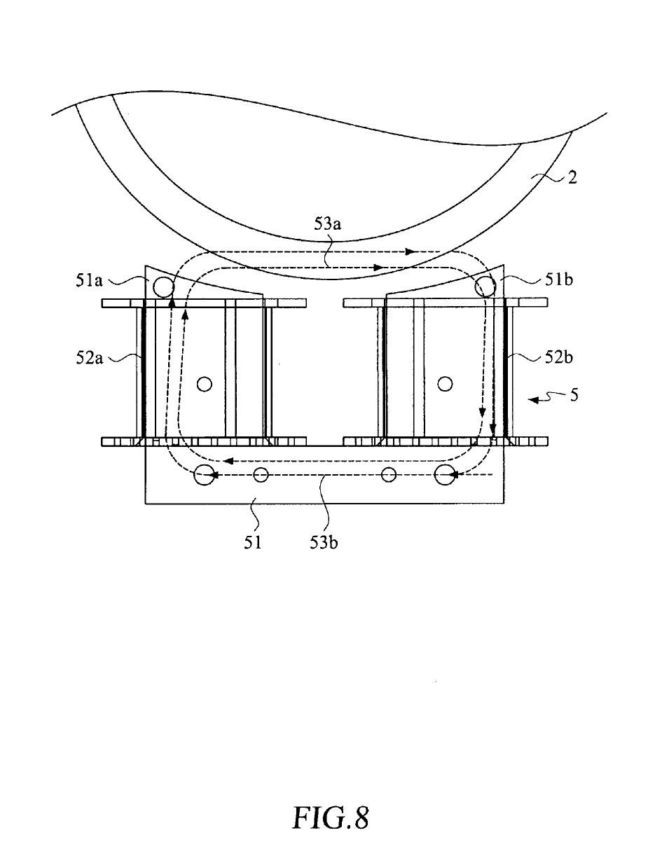

Please refer to FIG. 8. The brake mechanism 5 includes a core 51, and two sets of electromagnetic coils 52a, 52b. The core 51 has two electromagnetic coil winding sections 51a, 51b. The two electromagnetic coils 52a, 52b are wound on the two electromagnetic coil winding sections 51a, 51b, respectively. The core 51 may be a silicon steel core or a laminated iron core. The two sets of electromagnetic coils 52a, 52b may be connected to one another in series or in parallel.

The brake mechanism 5 would produce magnetic force when an amount of electric current is supplied thereto. The produced magnetic force may be represented by two magnetic lines 53a, 53b. That is, with the two sets of electromagnetic coils 52a, 52b, the magnetic force produced by the brake mechanism 5 of the present invention is doubled. For example, when each of the two electromagnetic coils 52a, 52b could produce a magnetic force of 1,000 gauss, then, total 2,000 gauss of magnetic force may be produced. As can be seen from FIG. 8, the magnetic lines 53a, 53b at the electromagnetic coil winding section 51b has a downward direction, and the magnetic lines 53a, 53b at the electromagnetic coil winding section 51a has an upward direction. Therefore, heat produced by the brake mechanism 5 is lower than that produced by the conventional brake mechanisms.

In the present invention, the length of each of the two sets of electromagnetic coils 52a, 52b for one ampere-turn is approximate to the length for one ampere-turn in the prior art using only one set of electromagnetic coil 13. However, the arrangement of two sets of electromagnetic coils 52a, 52b enables increased heat dissipation area to effectively lower the temperature of the electromagnetic coils 52a, 52b and accordingly, of the brake mechanism 5. As a result, the brake mechanism 5 may have enhanced brake efficiency. For example, in the illustrated first embodiment, the temperature of the electromagnetic coils 52a, 52b is around 80 to 90° C., which is lowered by 38% compared to the 145° C. of the electromagnetic coil 13 in the prior art.

The relation between the electromagnetic coil temperature and the current density is expressed by the following formula:

$$\frac{( temp coefficient + X 1 )}{( temp coefficient + X 2 )} = ( ratio of current density ) \times ( ratio of heat dissipation area )$$

wherein

X1 is the temperature of the electromagnetic coils 52a, 52b; and

X2 is the temperature of the electromagnetic coil 13 in the prior art.

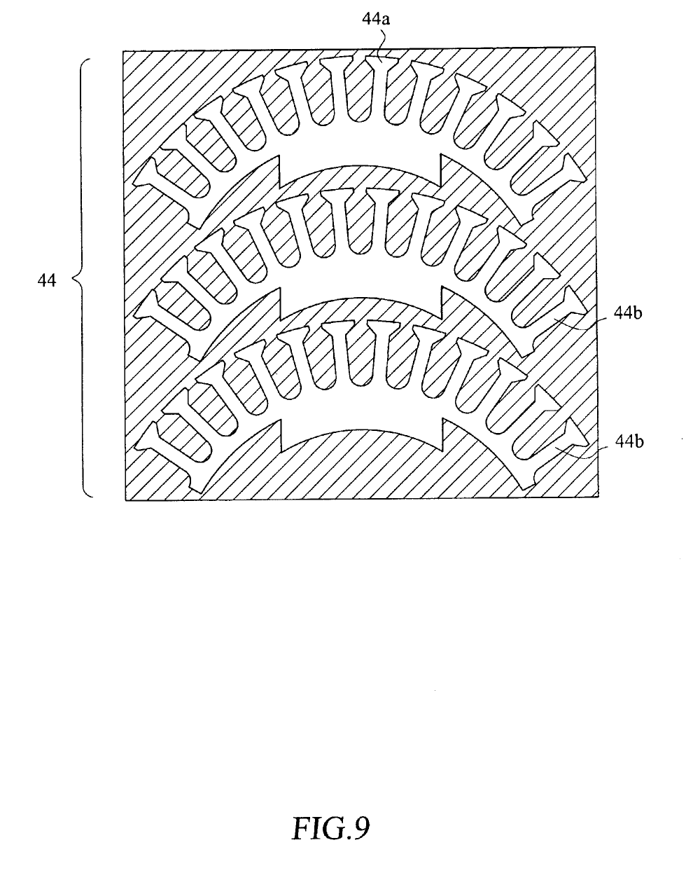

Please refer to FIG. 9 that shows a production of an annular silicon steel sheet 44 according to another embodiment of the annular silicon steel sheet of the present invention. The annular silicon steel sheet 44 in this embodiment includes three segments 44a, 44b, 44c, which are produced by punching one single piece of silicon steel material. In this embodiment, the use ratio of the silicon steel material is 36.7%, which is also higher than that in the prior art.

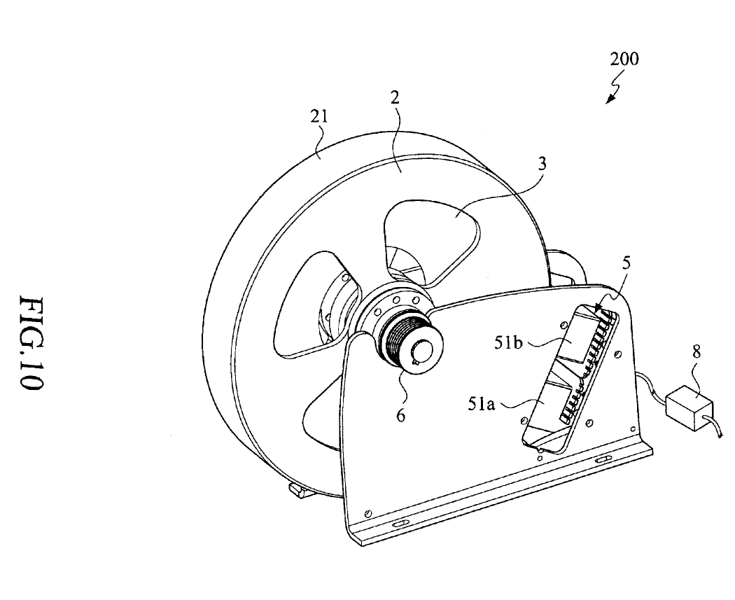

Please refer to FIG. 10 that is a perspective view of a brake arrangement 200 according to a second embodiment of the present invention. Since the second embodiment is generally structurally similar to the first embodiment, components that are the same or similar in the two embodiments are denoted by the same reference numerals. The second embodiment is different the first embodiment in that the brake arrangement 200 includes a power supply mechanism 8 while the laminated silicon steel structure 4 is omitted. The power supply mechanism 8 is electrically connected to the electromagnetic coils 52a, 52b of the brake mechanism 5 for supplying power to the brake mechanism 5, so as to substitute for the induced electromotive force produced by the coils 7 due to induction when the rotor 2 and the annular magnet 3 rotate synchronously.

Although the present invention has been described with reference to the preferred embodiments thereof and the best modes for carrying out the invention, it is apparent to those skilled in the art that a variety of modifications and changes may be made without departing from the scope of the present invention which is intended to be defined by the appended claims.

1. A brake arrangement, comprising:
a rotor;
an annular magnet located at an inner circumferential surface of the rotor;
a laminated silicon steel structure including an annular body and a plurality of coil winding sections equally spaced along and radially projected from an outer circumferential surface of the annular body; each of the coil winding sections having a polar end, which is oriented toward and spaced from an inner circumferential surface of the annular magnet by a predetermined clearance; and the laminated silicon steel structure being formed by stacking a plurality of annular silicon steel sheets, and each of the annular silicon steel sheets being assembled from a plurality of segments joined together at transverse seams; and
plural sets of coils being separately wound on the coil winding sections on the laminated silicon steel structure;
whereby when the rotor rotates, the annular magnet is driven by the rotor to rotate simultaneously, so that the plural sets of coils are induced to produce an electromotive force.

2. The brake arrangement as claimed in claim 1, further comprising a mount for holding the laminated silicon steel structure in place.

3. The brake arrangement as claimed in claim 1, further comprising a brake mechanism arranged in the vicinity of the rotor for generating and applying a braking force against the rotor.

4. The brake arrangement as claimed in claim 3, wherein the brake mechanism includes a core and at least two sets of electromagnetic coils; the core having two electromagnetic coil winding sections, on which the two sets of electromagnetic coils are separately wound.

5. The brake arrangement as claimed in claim 4, wherein the core of the brake mechanism is a silicon steel core.

6. The brake arrangement as claimed in claim 4, wherein the core of the brake mechanism is a laminated iron core.

7. The brake arrangement as claimed in claim 1, wherein each of the segments is provided at one of two ends with a male connector and at the other end with a mating female connector, such that the segments could be sequentially connected to form the annular silicon steel sheet through engagement of the male connector on one segment with the mating female connector on an adjacent segment.

8. The brake arrangement as claimed in claim 1, wherein the segments are identical in size.

9. The brake arrangement as claimed in claim 1, further comprising an iron ring mounted on an outer circumferential surface of the rotor.

10. A brake arrangement, comprising:
a rotor;
an annular magnet located at an inner circumferential surface of the rotor;
a brake mechanism disposed external to the rotor for generating and applying a braking force against the rotor; the brake mechanism including a core and at least two sets of electromagnetic coils; the core having two electromagnetic coil winding sections, on which the two sets of electromagnetic coils are separately wound; and
a power supply mechanism electrically connected to the electromagnetic coils of the brake mechanism for supplying power to the brake mechanism.

11. The brake arrangement as claimed in claim 10, further comprising a laminated silicon steel structure and plural sets of coils; the laminated silicon steel structure including an annular body and a plurality of coil winding sections equally spaced along and radially projected from an outer circumferential surface of the annular body; each of the coil winding sections having a polar end, which is oriented toward and spaced from an inner circumferential surface of the annular magnet by a predetermined clearance; and the plural sets of coils being separately wound on the coil winding sections of the laminated silicon steel structure.
